(19) United States
(12) Patent Application Publication
(10) Pub. No.: US 2020/0207032 A1
(43) Pub. Date: Jul. 2, 2020

(54) METHOD FOR PRODUCING A WIND TURBINE ROTOR BLADE

(71) Applicant: Wobben Properties GmbH, Aurich (DE)

(72) Inventors: Florian STOPS, Stassfurt, Neundorf (DE); Torsten BETHGE, Magdeburg (DE)

(21) Appl. No.: 16/615,096

(22) PCT Filed: Jun. 8, 2018
(86) PCT No.: PCT/EP2018/065131

§ 371 Date: Nov. 19, 2019

(30) Foreign Application Priority Data
Jun. 9, 2017 (DE) 10 2017 112 721.6

(51) Int. Cl. B29C 70/30; B29D 99/00

(52) U.S. Cl. CPC B29C 70/30; B29L 2031/085; B29D 99/0025

(57) ABSTRACT

There is provided a method of producing a wind turbine rotor blade. A mold for a spar cap is provided. The mold has at least one negative cap edge. Glass fiber layers are laid in the mold and in the negative cap edge to achieve transverse scarfing at the ends of the glass fiber layers in such a way that a spar cap having a negative scarfing is provided. The spar cap having the negative scarfing is installed in a core material of the rotor blade.

### BACKGROUND

### Technical Field

The present invention concerns a method of producing a wind turbine rotor blade.

### Description of the Related Art

FIG. 1 shows a diagrammatic cross-sectional view of a rotor blade of a wind turbine. The rotor blade typically comprises two shells, a first shell 10 representing the suction side and a second shell 20 representing the pressure side. Furthermore the rotor blade has a respective spar cap 40 at the suction side and the pressure side and bars 30 which connect the spar caps 40 at the suction side and the pressure side together. In that arrangement the spar caps 40 are fixedly joined to the material of the suction side and/or pressure side.

DE 10 2009 047 570 A1 describes a spar cap of a wind turbine and the production of such a spar cap. The spar cap comprises a plurality of individual layers of a glass fiber or carbon fiber fabric, that are placed in a mold. A vacuum film, if then placed in the mold and epoxy resin, is infused through the volume delimited by the mold and the vacuum film. When the resin is dried, the cap can then be put to use. The cap can then be provided at an inward side of the first or second shell (suction side or pressure side). The side walls of the mold can be of a slight inclination so that the ends of the spar cap can also be slightly inclined.

In the production of spar caps, the individual webs of fiber fabric are to be transversely scarfed. Foam wedges or foam triangles of different thicknesses can be used to achieve the scarfing.

Typically the spar caps are provided with a straight edge or end. For that purpose a first wedge of a softer material is provided and a second wedge of a harder material can be provided on the first wedge so that the spar cap has a softer material at its outer region.

Typically the spar caps are produced in a rectangular configuration in cross-section. During that process transverse scarfing can be simulated by foam wedges, in particular the foam wedge can be provided at the edges. That however is disadvantageous in regard to transportability of the spar caps as the soft foam wedges can be damaged.

In the production of the spar cap, a lower glass fiber layer can be inserted and a foam strip can be placed at the mold edges. That foam strip can then be in the form of a wedge which is scarfed negatively inwardly. The glass fiber fabric can then be placed in that negative scarfing. The glass fiber fabrics which constitute the main part of the spar cap have to be scarfed in the transverse direction in order to provide soft transitions between the spar cap which is in the form of a structural component and the sandwich which adjoins the blade upper and lower edges. The foam strip which is provided at the edge of the spar cap can be of a differing thickness whereby it is very costly to produced.

On the German patent application from which priority is claimed the German Patent and Trade Mark Office searched the following documents: DE 10 2009 047 570 A1, DE 10 2012 219 226 A1, DE 2010 002 432 A1, DE 103 36 461 A1 and US 2017/0 001 387 A1.

A foam wedge or a foam portion can be used when installing the spar cap in a rotor blade of a wind turbine. That foam portion can have a resin passage. Core material can then be provided.

### BRIEF SUMMARY

Provided is a method of improved production of a wind turbine rotor blade. In particular, provided is an improvement of the production of spar caps for wind turbine rotor blades.

Provided is a method of producing a wind turbine rotor blade. A mold for a spar cap is provided. The mold has at least one negative cap edge. Glass fiber layers are laid in the mold and in the negative cap edge to achieve transverse scarfing at the ends of the glass fiber layers in such a way that a spar cap having a negative scarfing is provided. The spar cap having the negative scarfing is installed in a core material of the rotor blade.

According to an aspect of the present invention the mold has a portion which has a scarfing.

According to a further aspect of the present invention the mold has at least one resin passage.

Provided is a spar cap for a wind turbine rotor blade without foam strips at the ends of the spar cap. That can be achieved in particular by the foam wedges being provided as part of the mold or by the wedges or foam wedges already being integrated into the mold for production of the spar cap. That admittedly leads to a more complicated mold but it improves the production method or production of the spar cap. Glass fiber layers can then be scarfed into the mold. In particular the glass fiber fabric layers can be scarfed high at the negative cap edge. That can achieve a desired transverse scarfing. The molding obtained in that case can match with a sandwich foam form produced by machine, in which case the sandwich foam can be inserted below or into the negative scarfing.

The spar cap is produced with a negative scarfing. The spar cap can be produced from glass fiber fabrics and the material of the spar cap thus represents a hard material or a hardened material.

According to an aspect of the present invention the foam portion can have a scarfing and a resin passage. The foam portion used for providing the resin passage can be positively scarfed so that it then goes together with the negative scarfing of the spar cap. In this case there can be a transition between a hard and a soft material at the transition between the glass fiber fabric of the spar cap and the foam portion.

No additional core material strips for height compensation are required by virtue of the production of the spar cap. The transverse scarfings of the individual fiber fabric components are retained, a gap-free positively locking relationship with the core material of the rotor shell is ensured and the component can be produced in trimming-free fashion.

According to an aspect of the invention a scarfing represents an end of a portion or element (for example the spar cap) which is beveled at an acute angle. Peeling stresses can be reduced by the scarfing so that the strength of the join is increased.

While in the state of the art spar caps are typically produced in a box mold and cap edge strips are used at the spar cap transition to the core material, gaps can occur between the spar cap and the core material. In contrast thereto, with the transverse scarfing of the fabric, there is a fixedly defined fabric width in respect of the spar cap, which is stepped or scarfed in the transverse direction. That can provide a positively locking and substantially gap-free transition between he core material, the rotor blade shell and the spar cap. That is achieved in particular by the negative scarfing of the spar cap.

Further configurations of the invention are subject-matter of the appendant claims.

### BRIEF DESCRIPTION OF THE SEVERAL VIEWS OF THE DRAWINGS

Advantages and embodiments by way of example of the invention are described in greater detail hereinafter with reference to the drawings.

FIG. 1 shows a diagrammatic cross-section of a wind turbine rotor blade according to the state of the art,

FIG. 2 shows a diagrammatic view of a wind turbine,

FIG. 3A shows a diagrammatic sectional view of a part of a rotor blade,

FIG. 3B shows a diagrammatic sectional view A-A in FIG. 3A,

FIG. 3C shows a diagrammatic sectional view B-B of the section shown in

FIG. 3A,

FIG. 4A shows a diagrammatic sectional view of a spar cap in the production thereof,

FIG. 4B shows a further diagrammatic sectional view of a spar cap in the production thereof,

FIG. 4C shows a further diagrammatic sectional view of a spar cap in the production thereof, and

FIG. 5 shows a diagrammatic cross-section of a part of a rotor blade according to an embodiment of the invention.

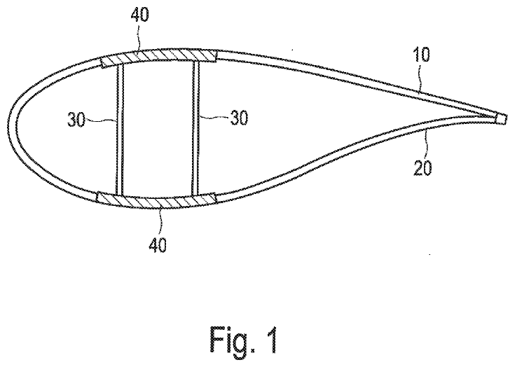

### DETAILED DESCRIPTION

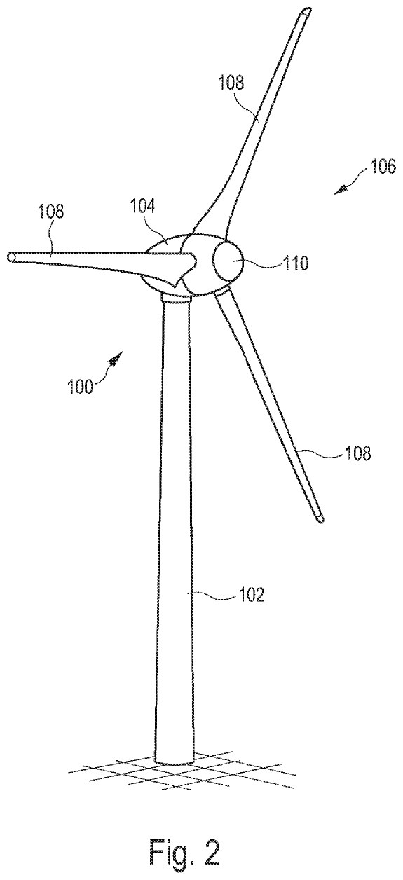

FIG. 2 shows a diagrammatic view of a wind turbine. The wind turbine 100 has a tower 102 and a pod 104 on the tower 102. Provided at the pod 104 is an aerodynamic rotor 106 having three rotor blades 200 and a spinner 110. The aerodynamic rotor 106 is caused to rotate in operation of the wind turbine by the wind and thus also rotates a rotor or rotor member of a generator coupled directly or indirectly to the aerodynamic rotor 106. The electric generator is arranged in the pod 104 and generates electric energy. The pitch angle of the rotor blades 200 can be varied by pitch motors at the rotor blade roots of the respective rotor blades 200.

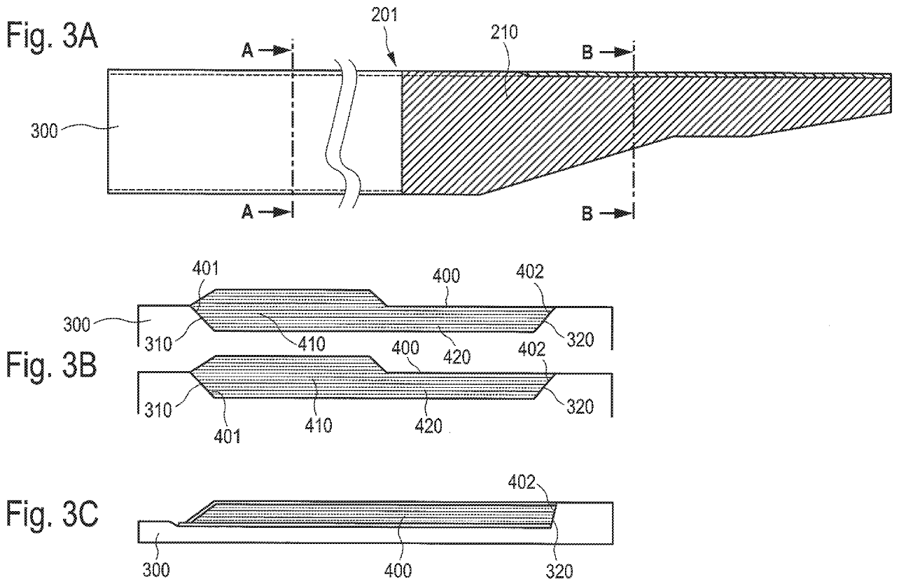

FIGS. 3A to 3D show various diagrammatic sectional views of a part of the rotor blade 200 in the production of a spar cap. FIG. 3B is a diagrammatic sectional view along section A-A and FIG. 3C is a diagrammatic sectional view along section B-B.

The method of producing a spar cap 400 for a rotor blade 200 of a wind turbine uses a mold 300 with especially designed mold edges 310, 320. FIGS. 3A to 3C show a front edge 201 of the spar cap. In addition a core material 210 of the rotor blade 200 is shown in FIG. 3A. FIGS. 3B and 3C show the mold 300 with the mold edges 310, 320 as well as the spar cap 400 with a first and a second end 401, 402.

According to an aspect of the present invention the angle of a first mold edge 310 can be 35° and the angle of a second mold edge 320 can be 22°. According to an aspect of the present invention those angles can be of a uniform configuration.

In FIG. 3B there can be provided a narrow cap 410 and/or a wide cap 420.

In FIG. 3C there is provided an alternative configuration of the mold 300 with a second mold edge 320.

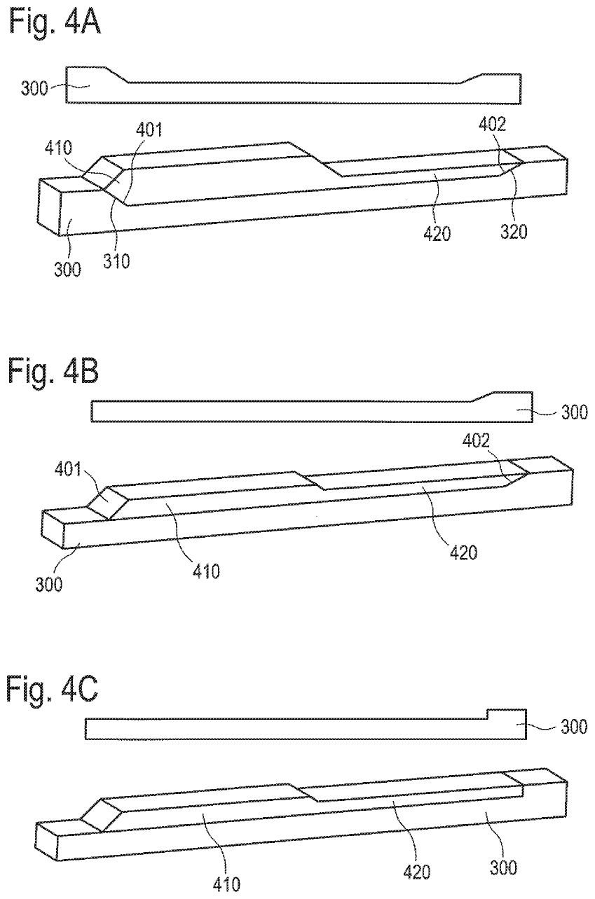

FIGS. 4A to 4C show various diagrammatic sectional views of a spar cap. FIGS. 4A to 4C respectively show the mold 300 (above) and the mold 300 with the spar cap 400. The configuration of the mold 300 and the spar cap 400 shown in FIG. 4A substantially corresponds to the configuration of the mold and the spar cap of FIG. 3B. The configuration of the mold and the spar cap of FIG. 4B substantially corresponds to that of the mold 300 and the spar cap 400 in FIG. 3C.

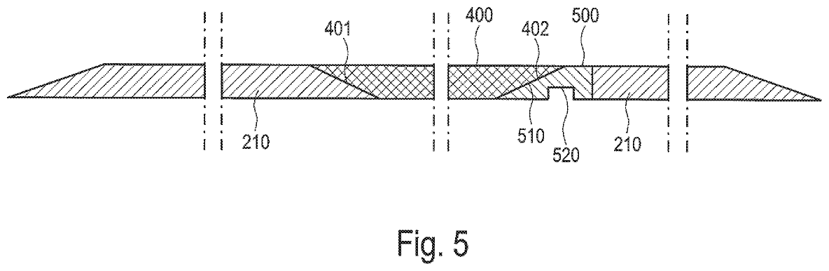

FIG. 5 shows a diagrammatic cross-section of a part of a rotor blade according to an embodiment of the invention. FIG. 5 shows the core material 210, a spar cap 400 having a first and a second end 401, 402 and optionally a foam inlay 500. The first and second ends 401, 402 of the spar cap respectively have a negative scarfing. The foam inlay 500 has an inclined end 510 and optionally a resin passage 520. The resin passage 520 can be provided at the opposite side in relation to the end 510.

As can be seen from FIG. 5 there is provided a spar cap 400 with its two end which each have a negative scarfing in a core material 210 of the rotor blade. The shallow angle of the spar cap in combination with that of the core material 210 permits a large-area, positively locking and gap-free transition between the spar cap and the core material of the rotor blade.

1. A method comprising:
producing a wind turbine rotor blade, wherein the producing comprises:
laying glass fiber layers in a mold having a negative cap edge to achieve transverse scarfing at ends of the glass fiber layers in such a way that a spar cap having a first end and a second end is formed, wherein at least one of: the first end or the second end has a negative scarfing, and
positively lockingly installing at least one of: the first end or the second end of the spar cap in a core material of the rotor blade.

2. The method according to claim 1 wherein the mold has a portion which has the negative scarfing.

3. The method according to claim 1 wherein the mold includes at least one resin passage.

4. The method according to claim 1 wherein the cap edge has an angle of between 20° and 40°.

5. A wind turbine rotor blade comprising:
at least one spar cap having a first end and a second end, wherein at least one of: the first or second end has a negative scarfing,
wherein at least one of: the first or second end of the spar cap is positively lockingly installed in a core material of the rotor blade.

6. The method according to claim 4, wherein the cap edge has an angle of between 22° and 35°.
